(19) United States
(12) Patent Application Publication
(10) Pub. No.: US 2013/0233189 A1
(43) Pub. Date: Sep. 12, 2013

(54) MULTI-LAYER PRINTING PROCESS

(71) Applicant: AMCOR GROUP GMBH, Zurich (CH)

(72) Inventors: Alain WITTMANN, Dombresson (CH); Ron PERRY, Thomaston, GA (US)

(73) Assignee: Amcor Group GMbH, Zurich (CH)

(21) Appl. No.: 13/786,692

(22) Filed: Mar. 6, 2013

Related U.S. Application Data
(60) Provisional application No. 61/607,080, filed on Mar. 6, 2012.

(51) Int. Cl. B41J 11/00

(52) U.S. Cl. CPC B41J 11/002
USPC 101/216; 101/483

(57) ABSTRACT

A system and method for forming indicia on a substrate. The system includes a feed system for feeding the substrate and a plurality of stations each operable to apply a processing step to the substrate. A first of the plurality of stations applies an energy curable ink to the substrate using a printing process. In some embodiments, this printing process is a gravure cylinder having indicia grooves formed on the gravure cylinder. The indicia grooves on the cylinder retain the energy curable ink until contact with the substrate whereby the energy curable ink is applied to the substrate. A curing unit is disposed downstream of the first of the plurality of stations. The curing unit receives the substrate and outputs an electron beam directed toward the energy curable ink to cure the energy curable ink and form a resultant energy curable layer upon the substrate.

### CROSS-REFERENCE TO RELATED APPLICATIONS

This application claims the benefit of U.S. Provisional Application No. 61/607,080, filed on Mar. 6, 2012. The entire disclosure of the above application is incorporated herein by reference.

### FIELD

The present disclosure relates to multi-layer printing processes and, more particularly, relates to a multi-layer printing processes and resultant product that employs an energy curable coating that provides advantages over conventional hot/cold foil stamping.

### BACKGROUND AND SUMMARY

This section provides background information related to the present disclosure which is not necessarily prior art. This section also provides a general summary of the disclosure, and is not a comprehensive disclosure of its full scope or all of its features.

In the printing and/or manufacturing industries, it is often desirable to print or otherwise apply indicia to a product container or other packaging. Traditionally, selection of the application process would revolve around the physical characteristics of the final indicia. In some applications, durability of the indicia was paramount (e.g. resistance to scuffing or damage). In some applications, appearance of the indicia was paramount (e.g. reflectivity). In some applications, durability, appearance, and/or other characteristics were desirable.

Conventionally, foil stamping, also known as hot foil stamping, hot stamping, dry stamping, cold foil imprinting, and leaf imprinting, was used to achieve a desired appearance in the final product. Generally speaking, hot stamping is a dry printing method in which a heated die and foil are used to apply graphics to a target surface. The process of hot stamping generally comprises heating a die defining a desired shape for the transfer, applying a metallic foil over the target surface, and, through a combination of heat, dwell time, and pressure, a partial transfer of the metallic foil, in the shape of the die, is transferred and bonded to the target surface.

Hot/cold foil stamping is often desirable because of it being a dry process that does not employ solvents or inks, and does not typically result in harmful vapors.

However, the quality of the foil stamping process is highly dependent on the quality of the fixture or anvil used to support the part to be printed. That is, the fixture must be supportive to reliably and repeatably position the part to be printed. Variation in either may compromise the quality of the stamping process.

It should be recognized that conventional foil stamping often requires substantial investment in machinery that is both cumbersome and costly.

Rotary hot/cold foil stamping can improve the processing rate of conventional foil stamping as it reduces the dwell time. This can, in turn, improve the resultant detail of the indicia. However, use of the rotary hot foil stamping system can be challenging in terms of trying to maintain the desired temperature of the die. In all cases, the die must be held securely in position in order to produce even depth of impression through heavy and light coverage regions of the die.

Unfortunately, there are limits to the complexity of foil stamping indicia. For example, foil stamping can be limited to specific surface topography. Moreover, foil stamping can be costly compared to ink printing.

Conventional ink printing, however, generally requires application of a printing ink on to the target surface and then is typically followed with application of a lacquer or other protective layer to enhance the appearance of the indicia (e.g. reflectivity) and protect the indicia. Unfortunately, conventional ink printing is not able to achieve the ultimate appearance of foil stamping; that is, conventional ink printing cannot generally achieve the reflectivity of foil printing.

However, in accordance with the present teachings, a novel multi-layer ink printing process is provided that overcomes the deficiencies of the conventional ink printing and is capable of at least matching, and in some embodiments surpassing, the appearance and durability of foil stamping.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustration of a printing system according to some embodiments of the present teachings;

FIG. 2A is a schematic cross-sectional view illustrating a product made in accordance with the multi-layer printing process of the present teachings according to some embodiments;

FIG. 2B is a schematic cross-sectional view illustrating a product made in accordance with the multi-layer printing process of the present teachings according to some embodiments; and

FIG. 3 is a schematic cross-sectional view illustrating a conventional foil stamping product.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

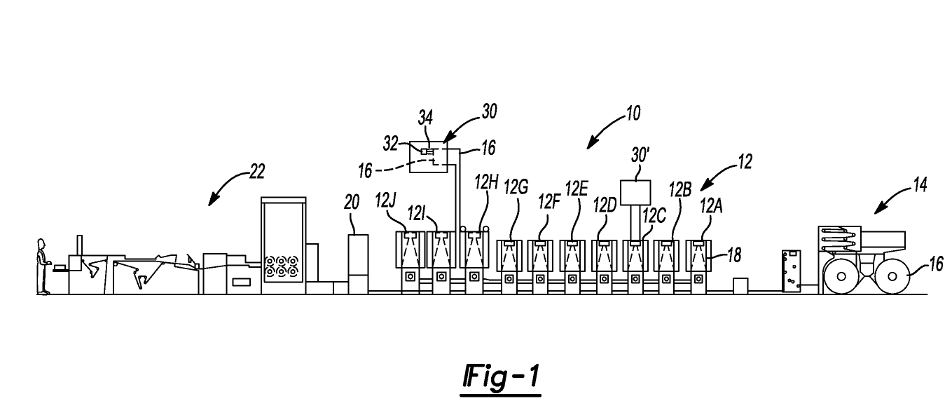

With particular reference to FIG. 1, a printing system 10 is provided according to the principles of the present teachings. In some embodiments, printing system 10 is based on a rotogravure (also known as a gravure) printing system. The system is generally an intaglio-type printing system that involves engraving the image onto an image carrier. In gravure printing, the image is engraved onto a cylinder for use in a rotary printing press configuration. However, it should be appreciated that the principles of the present teachings are not limited to only gravure type printing systems and are equally applicable to flexographic printing and the like. In flexographic printing, ink is transferred from a fountain roller to a flexible plate cylinder by a so-called anilox roller that meters the ink.

Generally speaking, the gravure process system is configured by first creating one or more cylinders with an engraved image to be printed. Engraving of the image on the cylinder can be accomplished according to any one of a number of techniques, including physical engraving (e.g. via a diamond stylus), etching (e.g. chemical etching), and the like. This engraved image is sized to contain the printing ink to be transferred to the substrate. In some embodiments, the substrate can comprise paper or other fibrous material, such as stock, cardboard, corrugated board, polyethylene, polypropylene, polyester, BOPP and the like. It should be noted, however, that alternative substrate materials can be used that are conventional in the art. As noted above, the invention is particularly advantageous for fibrous substrates such as paper or board that present a relatively rough surface. Boards usable in the invention typically have a grammage from about 160 g/m² to about 400 g/m², often in the range 180 to 280 g/m². This corresponds to a thickness in the range of about 180 to 400μ depending on the density of the board material. Paper substrates range typically from about 80 g/m² to about 160 g/m².

Generally, printing system 10 can comprise a plurality of stations 12, such as a first station 12A, a second station 12B, a third station 12C, a fourth station 12D, a fifth station 12E, a sixth station 12F, a seventh station 12G, an eighth station 12H, a ninth station 12I, and a tenth station 12J. It should be appreciated that printing system 12 can be configured with fewer or greater number of stations; however, the present embodiment represents at least one preferred embodiment. In some embodiments, each of the plurality of stations 12 can be configured for a different purpose, such as application of an energy curable ink (which will be discussed more completely herein), a different color, a different coating, or the like. In this regard, any one of a number of layering and processing patterns can be achieved on the substrate.

In some embodiments, printing system 10 can comprise a feed system 14 for supplying and feeding a substrate to be printed or web 16, such as paper, stock, cardboard, corrugated board, polyethylene, polypropylene, polyester, BOPP and the like, to each of the plurality of stations 12. Each of the plurality of stations 12 can comprise a printing cylinder 18 disposed therein. However, it should be recognized that each of the illustrated stations 12 do not require the use of a printing cylinder 18 as such station may be used for alternative purposes in some embodiments.

In some embodiments, printing system 10 can further comprise an optional inspection station 20. Inspection station 20 can be disposed in a downstream position relative to the plurality of stations 12. Inspection station 20 can automatically check and/or continually check the quality, rate, and condition of the now-printed substrate 16 and the resultant indicia contained thereon. The now-printed substrate 16 can then be final processed and palletized, if desired, in finishing station 22. Finishing station 22 can accomplish any one of a number of processing functions, such as creasing, die cutting, palletizing, and the like.

The printing system 10 further comprises at least one curing station 30. Curing station 30, in some embodiments, can be used for curing an energy curable ink deposited on substrate 16. According to some teachings of the present application, curing station 30 can comprise a beam unit 32 outputting an energy beam 34, such as an electron beam and/or an ultraviolet beam, directed at substrate 16. In some embodiments, a current can be placed across a filament causing electrons to be accelerated off the filament. These electrons can be used with an energy curable ink, such as an energy curable metallic ink, to cause a polymerization in the ink (herein referred to as EB curing). Beam unit 32 can comprise nitrogen to ensure the curing environment is inert, if desired. UV curing can also be under atmospheric condition. EB curing typically does not generate much heat and is therefore beneficial in many applications. However, as mentioned, UV curing can also be used in accordance with the present teachings, although they should not be regarded as obvious variants of each other as various technical and procedural differences exist between the two.

EB curing generally employs high-energy electrons. These electrons are generally not affected by the thickness of printing inks or the color of the ink. The electron beam 34 provides sufficient energy to cure thick coatings and/or pass through other substrates.

The energy curable ink of the present teachings can comprise, in some embodiments, an acrylate material that cures by free radical polymerization. Therefore, unlike other curing systems, a photoinitiator is not required. The electron energy is sufficient to cause the acrylate materials to polymerize by opening the acrylate bonds to form free radicals. These radicals then attack the remaining acrylate bonds until the reaction reaches completion. The result is a cured layer upon the substrate that is durable and provides previously-unattained reflectivity and optical characteristics using an ink-type application.

Process

While the printing system 10 is in operation, the engraved cylinder 18 is partially immersed in the ink fountain, filling the recessed cells with energy curable ink, conventional ink, and/or the like. As the cylinder rotates, it draws ink out of the fountain with it. Acting as a squeegee, a doctor blade scrapes the cylinder before it makes contact with the substrate, removing excess ink from the non-printing (non-recessed) areas and leaving in the cells the right amount of ink required. Next, the substrate gets sandwiched between the impression roller and the gravure cylinder, thereby transferring the ink to the substrate. The purpose of the impression roller is to apply force, pressing the substrate onto the gravure cylinder, ensuring even and maximum coverage of the ink. The capillary action of the substrate and the pressure from impression rollers force the ink out of the cell cavity and transfer it to the substrate. The substrate can then proceed to a dryer to completely dry before application of the subsequent layer.

The substrate 16 can include application of the energy curable ink at one or more of the plurality of stations 12. For example, the eighth station 12H can include application of an energy curable ink to substrate 16. Substrate 16 can continue its downstream processing, and be directed to curing station 30 (procedurally between eighth station 12H and ninth station 12I, whereby beam unit 32 outputs electron beam 34 directed at the energy curable ink from station 12H. Application of electron beam 34 to energy curable ink on substrate 16 (the EB coating) causes a polymerization or other curing process of energy curable ink. In some embodiments, several layers of coatings can be cured down to a single layer. As a result of this process, the energy curable ink is thus bonded or otherwise cured to substrate 16. It has been found that this process produces a resultant indicia (made from the now-cured energy curable ink) that can be tailored to provide any one of a number of reflectivity characteristics up to at least a mirror finish. In this way, the results of the present process are at least equivalent to foil stamping, but with additional flexibility. Moreover, the durability of the finish composition, in many applications, is sufficient so as to avoid the need for any additional layers or protective coatings, such as lacquer and the like.

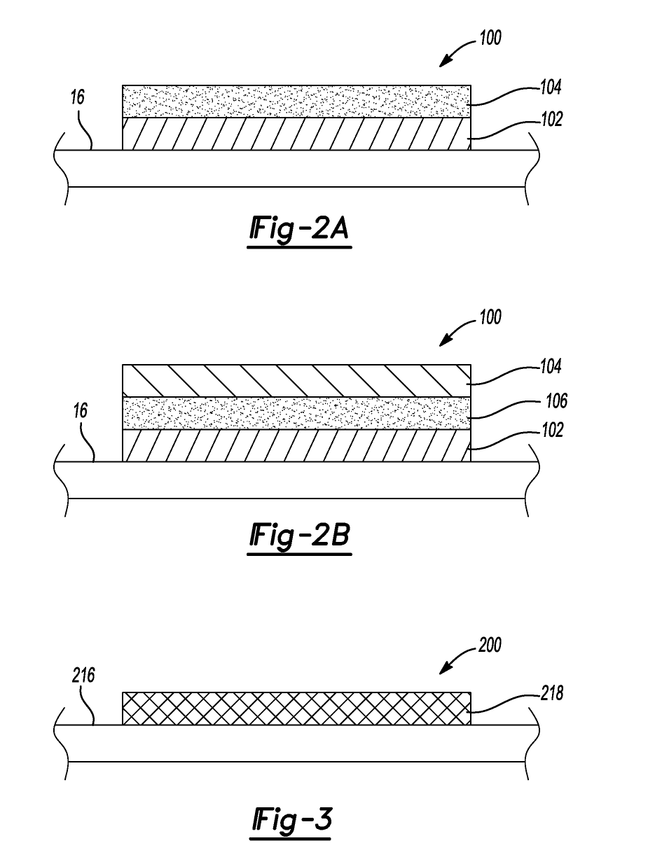

As a result of the aforementioned process, a product 100 is illustrated in FIG. 2A having a substrate 16, an energy cured layer 102, and an optional overcoat layer (e.g. lacquer) 104. In some embodiments as illustrated in FIG. 2B, product 100 can comprise substrate 16, an energy cured layer 102, a metallic ink layer 106 applied above energy cured layer 102, and an optional overcoat layer 104 disposed above metallic ink layer 106. In contrast, a conventional foil stamped product 200 illustrated in FIG. 3 having a substrate 216 and a foil stamping 218.

In some embodiments, if desired, metallic ink layer 106 (FIG. 2B) can be applied to the now-cured energy cured layer 102 to provide a high finish quality at station 12I or 12J. In some embodiments, the metallic ink used for metallic ink layer 106 can be conventional metallic ink that is available in an assortment of colors. It has been found that application of metallic ink layer 106 to the energy cured layer 102 creates a bond therebetween that results in increased durability of metallic ink layer 106 relative to conventional application of metallic ink layers. In some embodiments, an overcoat layer 104, which is discussed herein, may not be required to protect metallic ink layer 106. Moreover, the finish quality of the metallic ink layer 106 (being disposed upon energy cured layer 102) is enhanced (e.g. improved reflectivity) compared to metallic ink layers deposited directly on a substrate according to conventional processes.

In further embodiments, if desired, a lacquer or overcoat layer 104 can be applied to the now-cured energy cured layer 102 and/or metallic ink layer 106 to provide a high finish quality at station 12I or 12J and/or enhance durability. Notwithstanding, however, it has been found that because of the high finish quality provided by the now-cured energy cured layer 102 and/or metallic ink layer 106, application of this overcoat layer (see 104 of FIGS. 2A and 2B) is often not needed to enhance finish quality and, in some cases, application of this overcoat layer may in fact reduce the overall finish quality because of the high native quality of the energy cured layer 102. Moreover, in such applications that do not employ a lacquer or overcoat layer, the durability of the energy cured layer is often sufficient for many, if not all, applications.

Similar to curing station 30 positioned between stations 12H and 12I, a curing station 30′, having a similar construction, can be positioned between any other of the plurality of stations 12, such as between third station 12C and fourth station 12D. In such embodiments, additional or alternative energy cured coating layers can be applied and subsequently cured in curing station 30′.

According to the present discussion, it should be appreciated that the principles of the present teachings provide benefits over conventional foil stamping processes and also over applications intended to achieve a simulated foil/metalized solution or foil/metalized alternative, such as transfer metalized board or vacuum metalized PET, laminated on board, and other techniques.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A process for forming a printed product, said process comprising:
applying an energy curable ink to a substrate at a first station using a printing process;
curing said energy curable ink using an energy curable process at a second station downstream of said first station to define a cured energy curable layer; and
routing said substrate to a third station downstream of said second station.

2. The process according to claim 1 wherein said curing said energy curable ink using said energy curable process comprises curing said energy curable ink using an electron beam at said second station downstream of said first station to define said cured energy curable layer.

3. The process according to claim 1 wherein said curing said energy curable ink using said energy curable process comprises curing said energy curable ink using an ultraviolet beam at said second station downstream of said first station to define said cured energy curable layer.

4. The process according to claim 1, further comprising:
applying a metallic ink to said substrate at said third station, said metallic ink being applied over said cured energy curable layer to define a metallic ink layer.

5. The process according to claim 4, further comprising:
applying an overcoat layer to said substrate at a fourth station, said overcoat layer being applied over said metallic ink layer.

6. The process according to claim 1, further comprising:
applying an overcoat layer to said substrate at said third station, said overcoat layer being applied over said cured energy curable layer.

7. The process according to claim 1 wherein said applying said energy curable ink to said substrate at said first station using said printing process comprises applying said energy curable ink to said substrate at said first station using a gravure cylinder having indicia grooves formed on said gravure cylinder, said indicia grooves retaining said energy curable ink until contact with said substrate whereby said energy curable ink is applied to said substrate.

8. A system for forming an indicia on a substrate, said system comprising:
a feed system for feeding said substrate;
a plurality of stations each operable to apply a processing step to said substrate, a first of said plurality of stations applying an energy curable ink to said substrate using a printing process; and
a curing unit disposed downstream of said first of said plurality of stations, said curing unit receiving said substrate and outputting an energy beam directed toward said energy curable ink to cure said energy curable ink and form a resultant energy cured layer upon said substrate.

9. The system according to claim 8 wherein said energy beam is an electron beam.

10. The system according to claim 8 wherein said energy beam is an ultraviolet beam.

11. The system according to claim 8 wherein said curing unit outputs said energy beam directed toward said energy curable ink to polymerize said energy curable ink.

12. The system according to claim 8 wherein said curing unit outputs said energy beam directed toward said energy curable ink to polymerize said energy curable ink into a monolayer.

13. The system according to claim 8 wherein a second of said plurality of stations applies a metallic ink to said substrate.

14. The system according to claim 8 wherein a second of said plurality of stations applies a metallic ink to said substrate over said energy cured layer.

15. The system according to claim 14 wherein a third of said plurality of stations applies an overcoat to said substrate over said metallic ink and said energy cured layer.

16. The system according to claim 8 wherein a second of said plurality of stations applies an overcoat to said substrate over said energy cured layer.

17. The system according to claim 8 wherein said first of said plurality of stations applying said energy curable ink to said substrate using said printing process comprises said first of said plurality of stations applying said energy curable ink to said substrate using a gravure cylinder having an indicia depression formed on said gravure cylinder, said indicia depression retaining said energy curable ink until contact with said substrate whereby said energy curable ink is applied to said substrate.
